(19) United States
(12) Patent Application Publication
(10) Pub. No.: US 2022/0270192 A1
(43) Pub. Date: Aug. 25, 2022

(54) COMPUTERIZED-SYSTEM AND COMPUTERIZED-METHOD TO CALCULATE AN ECONOMIC FEASIBILITY ANALYSIS FOR AN URBAN PLANNING MODEL

(71) Applicant: URBAN DASHBOARD LTD, Herzliya (IL)

(72) Inventors: Daniela PAZ EREZ, Hofit (IL); Ziv LIVNAT, Kfar Vitkin (IL); Tal AZOGUI, Ganot Hadar (IL); Anat TALMOR, Haifa (IL)

(21) Appl. No.: 17/615,605

(22) PCT Filed: Jan. 28, 2021
(86) PCT No.: PCT/IL2021/050104

§ 371 Date: Dec. 1, 2021

Related U.S. Application Data
(60) Provisional application No. 62/967,058, filed on Jan. 29, 2020.

(51) Int. Cl. G06Q 50/26; G06Q 10/06

(52) U.S. Cl. CPC G06Q 50/26; G06Q 10/06313

(57) ABSTRACT

A computerized-system to provide an economic-feasibility-analysis for an urban-planning-model, is provided herein. An economic-viability module, in the computerized-system is operated for: receiving an urban-planning-model; importing the urban-planning-model into a visual programming language and environment; retrieving urban-site-related metadata from the urban-planning-model; according to the retrieved urban-site-related metadata, converting the urban-planning-model, to a parametric model, by a first pretrained machine learning model. The parametric model is having a plurality of model-parameters. Retrieving a preconfigured environment-set-of-parameters of an environment in a preconfigured distance radius from the received urban-planning-model. Forwarding the preconfigured environment-set-of-parameters to one or more economic-calculators. The one or more economic-calculators analyzes the plurality of model-parameters against the environment-set-of-parameters, by a set of rules and a second pretrained machine learning model; generating an economic-feasibility-analysis of the urban-planning-model, based on the analysis of the plurality of model-parameters, against the preconfigured environment-set-of-parameters; and presenting the economic-feasibility-analysis, on a display unit of a computerized-device.

### TECHNICAL FIELD

The present disclosure relates to the field of urban planning technology based on a data-driven decision support tool for urban planning decision making.

### BACKGROUND

The market of construction and planning is a big market estimated as 10% of the world's Gross domestic Product (GDP). The urban planning is a fundamental element in new development and urban renewal. It has long term implications not only on the development project itself, but also on the community and the local or even national economy. The planning process should address various wide scale urban parameters, alongside small-scale specific parameters and anticipate the implications of decisions.

Planners and policy makers are struggling with an increasing complexity of the urban environment, e.g., growing population and demographics changes, high density, climate change and demand for urban transport and sustainable mobility solutions, and the amount of available information.

The current tools which are solely focused on the planning process are outdated and do not interface with the amount of supporting data which is available. Furthermore, quantitative analysis of urban planning models, is rarely conducted early and consistently through the planning process, which makes it difficult to understand the relative performance of each scenario within an urban planning model.

The planning stage must take into account many factors as it influences not only a single building or complex, but an entire community. In addition, changes which are made in the development stage, cost much more relative to a change made in the planning stage, and are also inefficient.

For example, a failure to anticipate construction costs of a wide road in a hilly region, may double the infrastructure levies of the initial urban planning model. In another example, building costs of a mix of high-rise and townhouses may be more expensive per unit, than a layout of low-rise buildings, for the same quality of life. Yet, most urban plans do not use economical tools, such as cost benefit analysis that includes, density, phasing and life cycle costs.

Moreover, policy makers and planners should seek to explore and analyze multiple possible scenarios of the urban planning model, to make sound decisions. However, due to limited financial resources and time constrains, often only a handful of the possible scenarios are explored. Smart urban planning should seek to both save errors and costs and optimize the benefits a plan can offer.

Also, currently the economic aspect of the projects, during the land use and urban planning process is not taken into consideration. At best, policy makers are exposed to some relevant data and accordingly they operate by their mere intuition and experience, instead of having an evaluation of the economic feasibility and applicability of the urban planning model.

An economic analysis as well as other types of analysis, such as an economic analysis of an urban planning model and its environment, includes handling of a huge amount of unstructured data along with a large amount of metadata, which cannot be operated by human or even by a team, in a reasonable amount of time.

Therefore, there is a need for a technical solution that will be operated as a decision support tool for urban planning and will present an economical and financial lens to the planners in the early stage of the process. Furthermore, there is a need that the technical solution will provide an economic feasibility analysis and will evaluate, benchmark and forecast the economical differences between multiple alternatives throughout the entire planning process.

### SUMMARY

There is thus provided, in accordance with some embodiments of the present disclosure, a computerized-system to provide an economic feasibility analysis for an urban planning model.

Furthermore, in accordance with some embodiments of the present disclosure, the computerized-system includes: a plurality of databases, a memory to store the plurality of databases and a processor. The processor may be configured to operate an economic viability module.

Furthermore, in accordance with some embodiments of the present disclosure, the economic viability module includes: receiving an urban planning model in a design-object format; importing the received urban planning model into a visual programming language and environment; retrieving urban site related metadata from the urban planning model; according to the retrieved urban site related metadata, converting the urban planning model, which was imported into a visual programming language and environment, to a parametric model by a first pretrained machine learning model.

Furthermore, in accordance with some embodiments of the present disclosure, the parametric model may have a plurality of model-parameters.

Furthermore, in accordance with some embodiments of the present disclosure, the economic viability module may further include retrieving a preconfigured environment-set-of-parameters of an environment in a preconfigured distance radius from the received urban planning model.

Furthermore, in accordance with some embodiments of the present disclosure, the preconfigured environment-set-of-parameters is retrieved from the plurality of databases.

Furthermore, in accordance with some embodiments of the present disclosure, the economic viability module may further include forwarding the preconfigured environment-set-of-parameters to one or more economic calculators, wherein the one or more economic calculators analyze the plurality of model-parameters against the environment-set-of-parameters, by a set of rules and a second pretrained machine learning model.

Furthermore, in accordance with some embodiments of the present disclosure, the economic viability module may further include generating an economic feasibility analysis of the urban planning model, based on the analysis of the plurality of model-parameters, against the preconfigured environment-set-of-parameters; and presenting the economic feasibility analysis, on a display unit of a computerized device.

Furthermore, in accordance with some embodiments of the present disclosure, the economic feasibility analysis includes at least one of: (i) list of costs and (ii) value of the urban planning model, and (iii) cost-benefit analysis.

Furthermore, in accordance with some embodiments of the present disclosure, the list of costs includes at least one of: (i) construction implementation or installation costs per project or per segment (ii) infrastructure costs per project or per segment.

Furthermore, in accordance with some embodiments of the present disclosure, the construction costs include at least one of: (i) costs of construction and development project costs per unit or per tradable area; (ii) cost of construction of streets and roads per area; (iii) cost of open spaces development per area; and (iv) cost of mobility and parking solutions per area.

Furthermore, in accordance with some embodiments of the present disclosure, the value of the urban planning model includes at least one value of tradable areas of: (i) value of residential unit; and (ii) value of commercial area.

Furthermore, in accordance with some embodiments of the present disclosure, the cost-benefit analysis includes at least one of: i. plan economic feasibility analysis; ii. plan phasing economic feasibility analysis; iii. plan economic feasibility analysis urban renewal project; iv. plan economic feasibility analysis of levies and regulation benefits; and v. a program for public needs.

Furthermore, in accordance with some embodiments of the present disclosure, the plurality of model-parameters includes at least one indicator of: (i) economic indicators; (ii) environmental indicators; (iii) infrastructure development indicators; (iv) mobility indicators; (v) social indicators; and (vi) full implementation or structural implementation.

Furthermore, in accordance with some embodiments of the present disclosure, the economic indicators include at least one of: costs of construction; cost of parking solutions; value of tradeable areas; economic analysis; a program for public needs; and municipal balance indices.

Furthermore, in accordance with some embodiments of the present disclosure, the environmental indicators include at least one of: access to solar radiation rights; radiation; walkability; urban density; wind simulation of wind direction; street noise and pollution corridors; open spaces and parks access and ratio to population and density; and viewshed analysis.

Furthermore, in accordance with some embodiments of the present disclosure, the infrastructure development indicators include at least one of: (i) earthworks cut and fill analysis; (ii) watershed and drainage analysis; (iii) roads paving costs in relation to transportation requirements; (iv) infrastructure construction costs to residential units.

Furthermore, in accordance with some embodiments of the present disclosure, the mobility indicators include at least one of: space syntax grid network; analysis of walking distance to points of interest and attraction points; index-integrated planning public transport; street sections with street users; and transportation demand management distribution forecasts.

Furthermore, in accordance with some embodiments of the present disclosure, the economic feasibility analysis is a current value.

Furthermore, in accordance with some embodiments of the present disclosure, the economic feasibility analysis is a future value, wherein the future is a preconfigured period time in the future.

Furthermore, in accordance with some embodiments of the present disclosure, after the receiving of the urban planning model, presenting the urban planning model, in a graphic presentation, on a display unit associated with a computerized device.

Furthermore, in accordance with some embodiments of the present disclosure, a user is enabled to perform one or more modifications to the urban planning model, via an input device, and an estimation of economic viability is operated for the modified urban planning model.

Furthermore, in accordance with some embodiments of the present disclosure, a modification of the urban planning model includes a change of at least one object in the at least one object: (i) location; (ii) layout; (iii) typology; (iv) Floor Area Ratio (FAR) (v) parcel to lots division; (vi) entrance location and type (vii) right of passage; (viii) land uses; (ix) access to public transportation; (x) parking; (xi) setbacks lines; (xii) units size; (xiii) total tradable area; (xiv) service area ratio; (xv) underground layout and depth; (xvi) model entrances altitudes; (xvii) segments construction and marketing phasing and implementation ratio; (xviii) model population density; (xix) altitude; and (xx) regulatory and local public requirements.

Furthermore, in accordance with some embodiments of the present disclosure, the economic viability module is enabling a user to generate an urban planning model instead of receiving thereof via an input device.

Furthermore, in accordance with some embodiments of the present disclosure, the one or more economic model calculators are calculating zoning and local restrictions and provide output data that is used for the generating of the economic feasibility analysis of the urban planning model, based on shape and built volume and layouts of the urban planning model.

Furthermore, in accordance with some embodiments of the present disclosure, the urban planning model is a format selected from: (i) Computer-Aided Design (CAD) format; (ii) design considerations; (iii) constrains and rights; (iv) tables of constraints; (v) geo-data formats defining the area in one or more information layers; (vi) a combination of (i) through (v).

Furthermore, in accordance with some embodiments of the present disclosure, the urban plan model and the modifications to the urban plan model are presented on a display unit in a three-dimensional view or two-dimensional view.

Furthermore, in accordance with some embodiments of the present disclosure, the urban plan model and the modifications to the urban plan model are rendered by a Game engine.

### BRIEF DESCRIPTION OF THE DRAWINGS

FIG. 1 schematically illustrates a high-level diagram of a computerized system for providing an economic feasibility analysis for an urban planning model, in accordance with some embodiments of the present disclosure;

FIGS. 2A-2B are a high-level workflow of economic viability module, in accordance with some embodiments of the present disclosure;

FIG. 3 schematically illustrates a high-level diagram of a computerized system for providing an economic feasibility analysis for an urban planning model and to modifications thereof, in accordance with some embodiments of the present disclosure;

FIG. 4 schematically illustrates an example of a representation of an urban planning model and an economic feasibility analysis thereof, in accordance with some embodiments of the present disclosure;

FIG. 5 schematically illustrates an example of a representation of two alternatives of an urban planning model and an economic feasibility analysis thereof, in accordance with some embodiments of the present disclosure;

FIG. 6 schematically illustrates an example of a representation of an urban planning model with traffic and a detailed economic feasibility analysis, in accordance with some embodiments of the present disclosure; and

FIG. 7 schematically illustrates an example of entity category parcel and entity types of: parcel, lot, building line and building, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “environment” as used herein, refers to a spatial expression in terms of mathematics and geometry, For example, nearest neighbor.

The term “environmental analysis” as used herein, refers to a spatial analysis.

The term “infrastructure” as used herein, refers to a built environment. It includes buildings and transport, as well as electricity, gas, water and sanitation connections. Two main types of infrastructure within an urban area. The hard infrastructure and the soft infrastructure. The hard infrastructure refers to the physical connections between places that carry people, materials, information and energy. These ‘fixed’ things include roads, railways, pipes, and cables. They are frequently called hard infrastructure or fixed infrastructure. Soft infrastructure refers to all the institutions that maintain the economic, health, social, environmental, and cultural standards of a population. This includes educational programs, official statistics, parks and recreational facilities It includes both physical assets such as highly specialized buildings and equipment, as well as non-physical assets.

The term “mobility infrastructure costs” as used herein, refers to an infrastructure consists of physical components and software that enable integrating public transit, private mobility services, bicycling, and walking. To form integrated mobility systems. Such systems will make it easier for the urban population to use multiple modes of transportation, often on the same journey. Technologies such as autonomous driving and mobile data connectivity, alongside new transportation services, like ride-hailing and vehicle sharing. It may refer to a combination of infrastructure development indicators and mobility indicators.

The term “sustainability” as used herein refers to the integration of actions focused on three pillars: environmental, social, and economical. Implementing sustainable development focus on the pursuit of quality of life.

The term “quality of life” as used herein refers to the quality of life in a population or community—whether the economic, social and environmental systems that make up the community are providing a healthy, productive, meaningful life for all community residents, present and future.

The term “urban planning model” as used herein refers to a planning scheme and design of urban areas presented in two or more dimensions. The urban planning model is presented with geographic coordinates or specific geographical reference and may include metadata and information on zoning regulations land use and building bulk, such as restrictions and regulation.

The term “Geographic Information System (GIS) system” as used herein refers to computer and software tools for gathering and analyzing data connected to geographic locations and their relation to human or natural activity on earth.

The term “semantic segmentation” as used herein refers to a task of clustering parts of an image together which belong to the same object class. It is a form of pixel-level prediction because each pixel in an image is classified according to a category.

The term “construction costs” as used herein refers to a part of overall costs incurred during the development of a built asset, such as a building.

The term “two-dimensional (2D)” as used herein refers to a geometric setting where two parameters are required to define a position of an element.

The term “three-dimensional (3D)” as used herein refers to a geometric setting where three parameters are required to define a position of an element.

The term “multi-dimensional” as used herein refers to a setting where multiple parameters are required to define an element. Any mix of physical and arbitrary parameters value that are common to the domain.

The term “Life cycle cost (LCC)” as used herein refers to a method for evaluating the total cost of an asset over its life cycle including initial capital costs, maintenance costs, operating costs and the asset's residual value at the end of its life

The term “Cost Benefit Analysis (CBA)” as used herein, refers to a form of economic analysis that compares the relative cost to benefit, or the change in outcome for a unit of investment.

The CBA refers to a systematic process in which decisions relating to urban planning model proposals are analyzed to determine whether the benefits outweigh the costs, and by what margin. A CBA serves as a basis for comparing alternative proposals and making informed decisions about whether to proceed. In terms of proposed developments, by evaluating all the potential costs, and comparing these with possible revenues and other benefits that might derive from a new building, a decision maker is able to assess whether the proposal is financially worthwhile or whether an alternative is needed.

The term “Gross Development Value (GDV)” as used herein refers to an estimate of the open market capital value or rental value the development is likely to have once it is complete. It may be calculated as part of an initial development appraisal and may then be continually assessed to help determine whether the project is likely to be profitable.

Currently, construction companies are using Building information modeling (BIM) to support decision-making regarding urban planning model or a built asset, by generating and managing digital representations of physical and functional characteristics of places. However, the BIM is dealing with building level only and does not take into account “environmental” parameters, which may influence the cost-benefit analysis of the urban planning model.

Other commonly used systems are Geographic Information System (GIS) systems, which provide geographic data only without sufficient economic data.

Another approach that is used by the construction companies for decision-making is hiring service of consulting companies to provide reports. The reports are commonly related to a specific aspect of the urban planning model. However, these reports are expensive solutions that take a very long time to process and focus only on a specific aspect of the urban planning model which requires specific expertise.

Therefore, none of the existing solutions provides a tool to assess and predict economic and engineering implications of urban design alternatives. Accordingly, there is a need for a computerized-method and a computerized system for an economic feasibility analysis for an urban planning model that will provide planners, developers and policy and decision makers a tool that will examine economic and quality of life aspects or indicators of the urban planning model and its environment and may be used in real-time. The examined indicators may be infrastructure, mobility infrastructure costs, sustainability and quality of life indicators.

Moreover, the needed technical solution also has to provide a visual representation of the urban planning model and the impact of a change in parameters e.g., alternative urban planning models, according to parametric calculations.

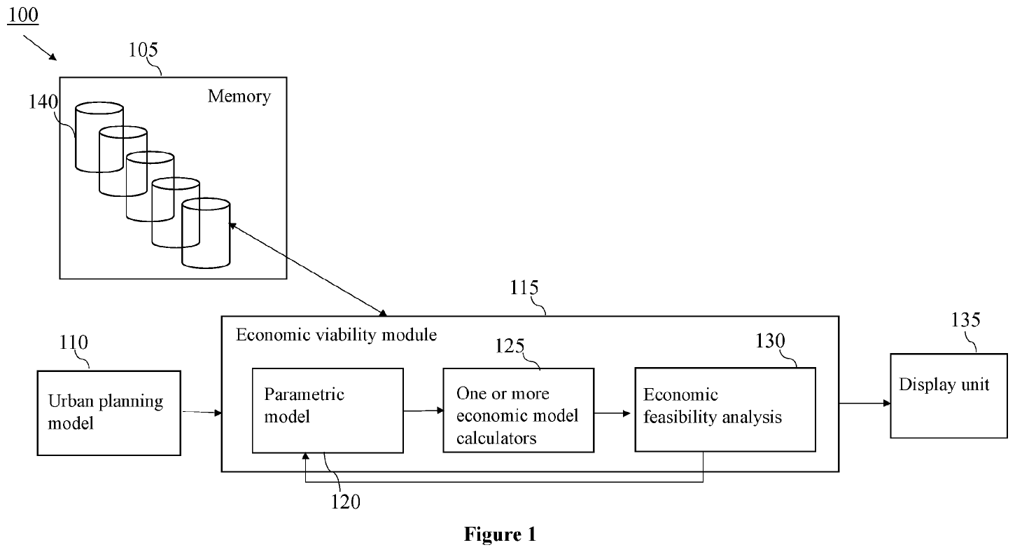

FIG. 1 schematically illustrates a high-level diagram of a computerized system 100 for providing an economic feasibility analysis for an urban planning model, in accordance with some embodiments of the present disclosure.

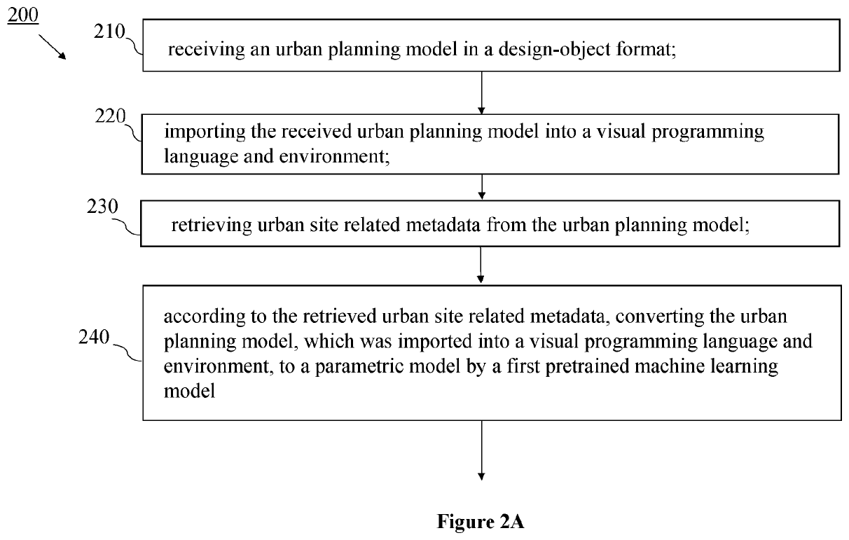

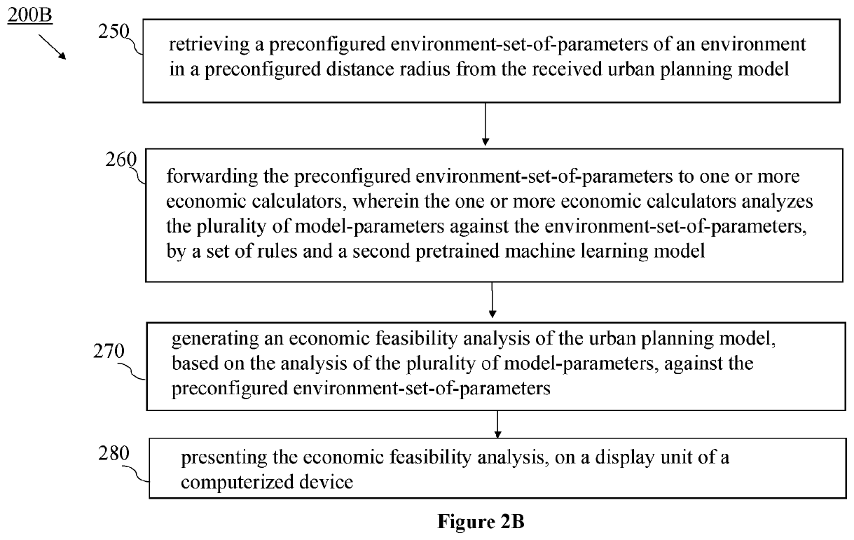

According to some embodiments of the present disclosure, in a computerized system 100, having a plurality of databases 140, a memory 105 to store the plurality of databases and a processor (not shown), the processor may be configured to operate an economic viability module, such as economic viability module 115 and such as economic viability module 200 in FIGS. 2A-2B.

According to some embodiments of the present disclosure, an urban planning model, such as urban planning model 110 may be received by an economic viability module, such as economic viability module 115 and such as economic viability module 200 in FIGS. 2A-2B. According to some embodiments of the present disclosure, the urban planning model 110 may be presented on a display unit in a two-dimensional (2D) or three-dimensional (3D) representation.

According to some embodiments of the present disclosure, the urban planning model 110 may be in Computer-Aided Design (CAD) format.

According to some embodiments of the present disclosure, the economic viability module 115 and such as economic viability module 200 in FIGS. 2A-2B may be implemented in a cloud-based computing environment.

According to some embodiments of the present disclosure, the urban planning model 110 may be an object in any architectural planning file format, such as Revit file (RVT) format, Sketchup file (SKP) format, OBJ file format and Computer Aided Design (CAD) file format.

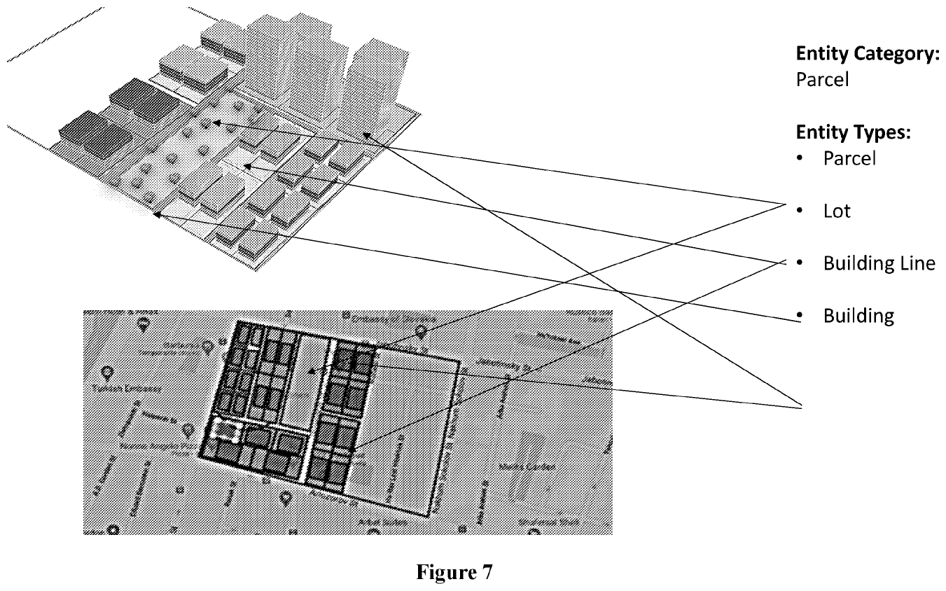

According to some embodiments of the present disclosure, the urban planning model 110 may be further including urban site related metadata. The urban planning model 110 may include a collection of structures or buildings, each represented by a compatible polygon shape. The structures may be arranged in annotated layers. The arrangement of layers may enable to separate different elements of the representation of the urban planning model and its parameters, i.e., metadata. For example, the arrangement of layers may include: a layer for a parcel, a layer for a lot, a layer for a building line and a layer for a building as illustrated in FIG. 7. An entity, such as a parcel may be represented by its associated layers and parameters which may define coordinates of a lot polygon in the parcel, building line and building.

According to some embodiments of the present disclosure, the layer that is describing a parcel may be defined by a lot location in the parcel, lot area, building floor area, in the lot: number of commercial floors in buildings, number of floors of public usage in buildings, number of floors of office space, number of floors of residential usage in buildings and the like.

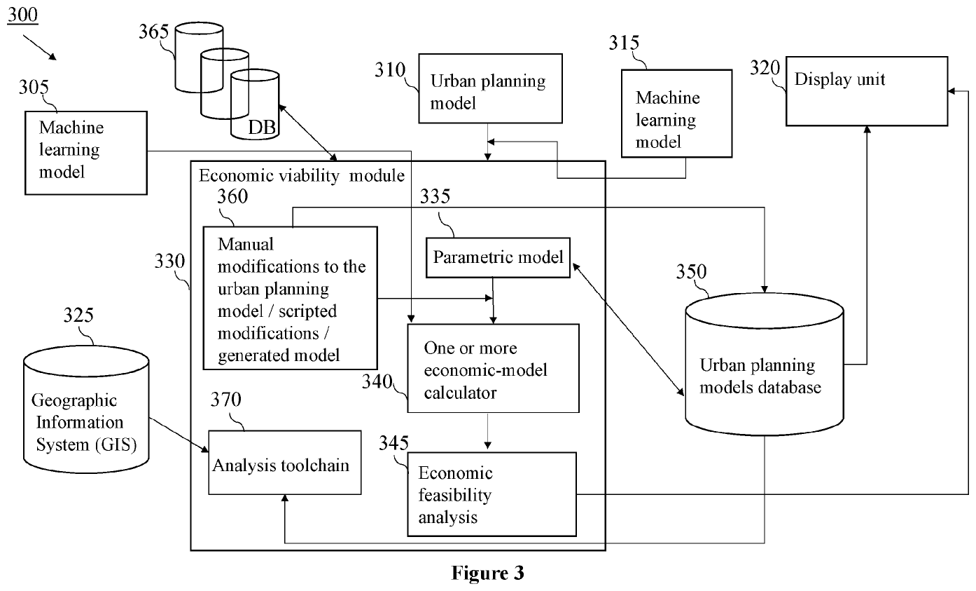

According to some embodiments of the present disclosure, an economic viability module, such as economic viability module 115 and such as economic viability module 200 in FIGS. 2A-2B may import the urban planning model 110 into a visual programming language and environment, such as grasshopper (GHX) file or AutoCAD and then according to the urban site related metadata, convert the urban planning model 110 to a parametric model, such as parametric model 120. The conversion into the parametric model 120 may be operated according to an algorithm or may be supported by a pretrained machine learning model, such as machine learning model 315 in FIG. 3.

According to some embodiments of the present disclosure, the economic viability module, such as economic viability module 115 and such as economic viability module 200 in FIGS. 2A-2B, may provide drawings, having polygons, according to a preconfigured legend to describe structures and outlines for elements within the urban planning model 110, and their uses.

According to some embodiments of the present disclosure, the economic viability module, such as economic viability module 115 and such as economic viability module 200 in FIGS. 2A-2B, may identify elements in the urban planning model 110 and boundaries of the identified elements and may classify the elements.

According to some embodiments of the present disclosure, the economic viability module, such as economic viability module 115, may extract the element's parametric representation. For example, some economic parameters may be used to characterize the representation, as computed in the economic viability module, such as profit/value/cost per model unit.

According to some embodiments of the present disclosure, the economic viability module, such as economic viability module 115 may group the structures according to a predefined set of rules for each of the structures which were grouped together.

According to some embodiments of the present disclosure, the economic viability module, such as economic viability module 115, may identify patterns of ordered structures by using available geometric information, i.e., surface polygons and their dispersion in space.

According to some embodiments of the present disclosure, the parametric model 120 may have a plurality of model-parameters. The plurality of model-parameters may include at least one indicator of: (i) economic indicators; (ii) environmental indicators; (iii) infrastructure development indicators; (iv) mobility indicators; and (v) full implementation or structural implementation.

According to some embodiments of the present disclosure, the economic viability module, such as economic viability module 115, may process a large amount of unstructured data, coupled to huge amounts of urban site related metadata.

According to some embodiments of the present disclosure, the economic viability module, such as economic viability module 115 may retrieve relevant information from data which has been stored in a plurality of databases, such as databases 140. The relevant information may be a preconfigured environment-set-of-parameters of an environment in a preconfigured distance radius from the received urban planning model.

According to some embodiments of the present disclosure, the economic viability module, such as economic viability module 115, may be forwarding the preconfigured environment-set-of-parameters to one or more economic model calculators, such as one or more economic model calculators 125.

According to some embodiments of the present disclosure, the one or more economic model calculators 125 may analyze the plurality of model-parameters against the environment-set-of-parameters, by a second pretrained machine learning model, such as machine learning model 305, in FIG. 3.

According to some embodiments of the present disclosure, each of the one or more economic model calculators 125, may be based on one or more numeric analysis tools having a plurality of model-parameters, such as: any of the developed and built-up areas and volume parameters e.g., total area, construction areas, ratio of construction area to total, building area, number of floors per each building, parking area, underground building, and any of the influencing, restricting or enabling parameters such as commerce accompanying entrance floor, main service area ratio, number of units, average size per housing unit, underground floors, number of balconies, average balcony size, single lane road, two-lane road, bicycle path, public transport route, sidewalk, green open public space, green private open space, public structure, mixed structure, commercial building area, hotels area, industrial area, logistics area, area of educational institution, transportation center area, parking space, student living space, office space, other area and the like.

According to some embodiments of the present disclosure, the machine learning model may allow initial screening and clustering, as well as to address semantic segmentation of the various design regions and components. For example, buildings of various typologies may be identified or generated through the parametric model learning capabilities.

According to some embodiments of the present disclosure, parametric model learning capabilities may be studied to predict accurate parametric components, such as “design-structure” typologies and dimensions. According to some embodiments of the present disclosure, Generative Adversarial Networks (GAN), produce images that capture the predominant visual properties of an urban context. GAN may be utilized by the economic viability module 115 to identify or label partially missing e.g., poorly represented, inherent components to the urban planning model 110, such as roads, parks, other.

According to some embodiments of the present disclosure, when addressing the parametric model learning capabilities architecture the parameter characteristics may be represented as trained embeddings e.g., basic initial input layer, to capture their various semantic meaning thus, handling the vast amount of features which were derived from the preconfigured environment-set-of-parameters that are characterizing each urban planning model and its alternatives.

According to some embodiments of the present disclosure, the economic viability module 115 may evaluate benchmarks and forecast the economical differences between multiple urban planning model alternatives. Each alternative may be graphically and visually geo modeled and presented on a display unit, such as display unit 135 for editing and reviewing of the users with a configurable template urban planning dashboard. Each urban planning model may be reviewed and compared to both benchmark models and both user-generated or algorithm based urban planning model alternatives.

According to some embodiments of the present disclosure, the economic viability module 115 may operate machine learning models with a score or penalty function to guide the process of selection of preconfigured environment-set-of-parameters of the urban planning model 110, and to propose various alternatives to the urban planning model 110, when the various of urban planning models spans a large space with multiple local “design” optimization fits objective matched within the maxima and minima defined space, such that for each successful design optimization iteration, there may be other successful solutions (as good as—or better) in other computation iterations.

According to some embodiments of the present disclosure, the parametric model 120 may score each modification, i.e., alternative of the urban planning model with a multi-label annotation, each with its own scoring-reference that is representing a bias to a real-life qualitative parameter. These multi-label scoring may be presented as is to enable involvement of a human-judgement in the process of the economic viability module 115.

According to some embodiments of the present disclosure, a parametric movement of economic viability module 115 may trigger an operation one or more economic model calculators 125 and an economic feasibility analysis 130.

According to some embodiments of the present disclosure, data from the economic feasibility analysis 130 may be reentered into the parametric model 120.

According to some embodiments of the present disclosure, the economic viability module 115 may implement basic numerical coding tools and may allow utilization of parallel computations e.g. relying on a Graphic Processing Unit (GPU), or various distributed computations infrastructure common in big data deployments.

According to some embodiments of the present disclosure, the one or more economic model calculators may be based on linear regression by a pretrained machine learning model, such as machine learning model 305, in FIG. 3.

According to some embodiments of the present disclosure, a large-scale urban planning model 110 having a multitude of parameters may require the economic viability module 115 to be carried out by computerized platforms having high level of flexibility and response time, as well as ease of use for the end user. For example, Grasshopper 3D, a visual programming language and environment that runs within a Rhinoceros 3D computer-aided design (CAD) application, CityEngine 3D modeling software for urban environments, Dynamo Studio, a programming environment for computational BIM design and the like.

According to some embodiments of the present disclosure, the one or more economic calculators 125 may analyze the plurality of model-parameters against an environment-set-of-parameters, by a set of rules and may also be supported by a machine learning model, such as pretrained machine learning model 305 in FIG. 3, to generate an economic feasibility analysis 130 of the urban planning model 110, based on the analysis of the plurality of model-parameters, against the environment-set-of-parameters.

According to some embodiments of the present disclosure, the urban planning model may be presented on a display unit 135, which is associated to a computerized device. The economic feasibility analysis 130 may be also presented on the display unit 135.

According to some embodiments of the present disclosure, the economic feasibility analysis 130 may include at least one of: (i) list of costs and (ii) value of the urban planning model, and (iii) cost-benefit analysis.

According to some embodiments of the present disclosure, the list of costs may include at least one of: (i) construction implementation or installation costs per project or per segment (ii) infrastructure costs per project or per segment.

According to some embodiments of the present disclosure, the construction costs may include at least one of: (i) costs of construction and development project costs per unit or per tradable area; (ii) cost of construction of streets and roads per area; (iii) cost of open spaces development per area; and (iv) cost of mobility and parking solutions per area.

According to some embodiments of the present disclosure, the value of the urban planning model 110 may include at least one value of commercial areas of: (i) value of residential unit; and (ii) value of commercial area.

According to some embodiments of the present disclosure, the cost-benefit analysis may include at least one of: (i) plan economic feasibility analysis; (ii) plan phasing economic feasibility analysis; (iii) plan economic feasibility analysis urban renewal project; (iv) plan economic feasibility analysis of levies and regulation benefits; and (v) program for public needs.

According to some embodiments of the present disclosure, the plurality of model-parameters that are included in the parametric model 120 may include at least one indicator of: (i) economic indicators; (ii) environmental indicators; (iii) infrastructure development indicators; (iv) mobility indicators; and (v) full implementation or structural implementation.

According to some embodiments of the present disclosure, the economic indicators may include at least one of: costs of construction; cost of parking solutions; value of tradeable areas; economic analysis; a program for public needs; and municipal balance indices.

According to some embodiments of the present disclosure, the environmental indicators may include at least one of: access to solar radiation rights; radiation; walkability; urban density; wind simulation of wind direction; street noise and pollution corridors; open spaces and parks access and ratio to population and density; and viewshed analysis.

According to some embodiments of the present disclosure, the infrastructure development indicators include at least one of: (i) earthworks cut and fill analysis; (ii) watershed and drainage analysis; (iii) roads paving costs in relation to transportation requirements; (iv) infrastructure construction costs to residential units.

According to some embodiments of the present disclosure, the mobility indicators include at least one of: space syntax grid network; analysis of walking distance to points of interest and attraction points; index-integrated planning public transport; street sections with street users; and transportation demand management distribution forecasts.

According to some embodiments of the present disclosure, the economic feasibility analysis may be in current value or in future value.

According to some embodiments of the present disclosure, when the economic feasibility analysis is in future value it may be in a preconfigured period time in the future.

According to some embodiments of the present disclosure, after the receiving of the urban planning model 110, the economic viability module 115 may be presenting the urban planning model, in a graphic presentation, on a display unit 135 is associated with a computerized device.

According to some embodiments of the present disclosure, a user may be enabled by the economic viability module to perform one or more modifications to the urban planning model, via an input device. Accordingly, an estimation of economic viability 115 may be operated for the modified urban planning model. The modified urban planning model and the economic feasibility analysis may be presented on the display unit 135. The modified urban planning model may be rendered by a game engine before it may be presented on the display unit 135.

According to some embodiments of the present disclosure, the urban plan model 110 and the modifications to the urban plan model may be presented on the display unit 135 in a three-dimensional view or two-dimensional view.

According to some embodiments of the present disclosure, a search algorithm dedicated to multi-objective search may be enabled by the economic viability module 115 to perform one or more modifications to the urban planning model, via an input device, and wherein an estimation of economic viability is operated for each of the modified urban planning models for performance assessment.

According to some embodiments of the present disclosure, a modification of the urban planning model may include a change of at least one object in the at least one of:

(i) location; (ii) layout; (iii) typology; (iv) Floor Area Ratio (FAR) (v) parcel to lots division; (vi) entrance location and type (vii) right of passage; (viii) land uses; (ix) access to public transportation; (x) parking; (xi) setbacks lines; (xii) units size; (xiii) total tradable area; (xiv) service area ratio; (xv) underground layout and depth; (xvi) model entrances altitudes; (xvii) segments construction and marketing phasing and implementation ratio; (xviii) model population density; (xix) altitude; and (xx) regulatory and local public requirements.

According to some embodiments of the present disclosure, the economic viability module 115 may enable a user to generate an urban planning model instead of receiving thereof, via an input device.

According to some embodiments of the present disclosure, the one or more economic model calculators 125 may calculate zoning and local restrictions and may provide output data that may be used for the generating of the economic feasibility analysis of the urban planning model, based on shape and built volume and layouts of the urban planning model.

According to some embodiments of the present disclosure, the urban planning model 110 may be in a format such as Computer-Aided Design (CAD) format. Alternatively, the urban planning model 110 may include design considerations or constrains and rights or tables of constraints or geo-data formats defining the area in one or more information layers. In yet another alternative, the urban planning model 110 may be a combination of one or more of the alternatives.

FIGS. 2A-2B are a high-level workflow of economic viability module 200, in accordance with some embodiments of the present disclosure.

According to some embodiments of the present disclosure, operation 210 may comprise receiving an urban planning model in a design-object format.

According to some embodiments of the present disclosure, operation 220 may comprise importing the received urban planning model into a visual programming language and environment.

According to some embodiments of the present disclosure, operation 230 may comprise retrieving urban site related metadata from the urban planning model.

According to some embodiments of the present disclosure, operation 240 may comprise according to the retrieved urban site related metadata, converting the urban planning model, which was imported into a visual programming language and environment, to a parametric model by a first pretrained machine learning model. The parametric model may have a plurality of model-parameters

According to some embodiments of the present disclosure, operation 250 may comprise retrieving a preconfigured environment-set-of-parameters of an environment in a preconfigured distance radius from the received urban planning model.

According to some embodiments of the present disclosure, operation 260 may comprise forwarding the preconfigured environment-set-of-parameters to one or more economic calculators, wherein the one or more economic calculators analyzes the plurality of model-parameters against the environment-set-of-parameters, by a set of rules and a second pretrained machine learning model.

According to some embodiments of the present disclosure, operation 270 may comprise generating an economic feasibility analysis of the urban planning model, based on the analysis of the plurality of model-parameters, against the preconfigured environment-set-of-parameters.

According to some embodiments of the present disclosure, operation 280 may comprise presenting the economic feasibility analysis, on a display unit of a computerized device.

FIG. 3 schematically illustrates a high-level diagram of a computerized system 300 for providing an economic feasibility analysis for an urban planning model and to modifications thereof, in accordance with some embodiments of the present disclosure.

According to some embodiments of the present disclosure, an urban planning model, such as urban planning model 310 and such as urban planning model 110 in FIG. 1, may be received in a design-object format by economic viability module, such as economic viability module 330 and such as economic viability module 115 in FIG. 1. The urban planning model 310 may be imported into a visual programming language and environment, such as grasshopper (GHX) file or AutoCAD.

According to some embodiments of the present disclosure, the urban planning model 310 may be comprised of a plurality of polygons, where each polygon represents a structure in the urban planning model 310.

According to some embodiments of the present disclosure, the economic viability module 330 may retrieve urban site related metadata from the urban planning model 310. Based on the retrieved urban site related metadata, the economic viability module 330 may convert the urban planning model 310, which was imported into a visual programming language and environment, to a parametric model, such as parametric model 335 and parametric model 120, in FIG. 1.

According to some embodiments of the present disclosure, the economic viability module 330 may utilize a first pretrained machine learning model 315 for the conversion. Such that classes and ranges of parameters are detected and enhanced with the parametric model pretrained-learning, specifying missing design plan parameters in the model—as typical architecture dimensions and ratios.

According to some embodiments of the present disclosure, the parametric model 335 of the urban planning model may be stored in a database, such as urban planning models database 350.

According to some embodiments of the present disclosure, manual modifications to the urban planning model 310 or scripted modifications or a generated model 360 may be also stored in the urban planning models database 350.

According to some embodiments of the present disclosure, the parametric model 335 may have a plurality of model-parameters.

According to some embodiments of the present disclosure, the economic viability module 330 may retrieve a preconfigured environment-set-of-parameters of an environment in a preconfigured distance radius from the received urban planning model 310 from a plurality of databases, such as databases 365.

According to some embodiments of the present disclosure, the economic viability module 330 may forward the preconfigured environment-set-of-parameters to one or more economic calculators, such as one or more economic calculators 340 and one or more economic model calculator 125, in FIG. 1. The one or more economic calculators 340 may analyze the plurality of model-parameters against the environment-set-of-parameters, by a set of rules and a second pretrained machine learning model, such as machine learning model 305.

According to some embodiments of the present disclosure, the economic viability module 330 may generate an economic feasibility analysis 345 such as economic feasibility analysis 130 in FIG. 1, of the urban planning model 310, based on the analysis of the plurality of model-parameters, against the environment-set-of-parameters.

According to some embodiments of the present disclosure, the analysis of the plurality of model-parameters, against the environment-set-of-parameters may be gradually replaced by an analysis of a second pretrained machine learning model against the environment-set-of-parameters.

According to some embodiments of the present disclosure, the analysis of the plurality of model-parameters, against the environment-set-of-parameters may be operated by the second machine learning model only, when the dataset has already been processed on various urban planning models.

According to some embodiments of the present disclosure, the economic viability module 330 may present the economic feasibility analysis 345, on a display unit 320 of a computerized device.

According to some embodiments of the present disclosure, an analysis toolchain, such as analysis toolchain 370 may utilize Geographic Information System (GIS) 325 for various analyses, such as walkability, traffic, energetics, light/shadow and the like.

According to some embodiments of the present disclosure, the one or more economic calculators 340 may be economic models of structural engineering which were designed by civil engineers and economists which may be part of the economic viability module 330 or may be external economic calculators integrated into the economic viability module 330.

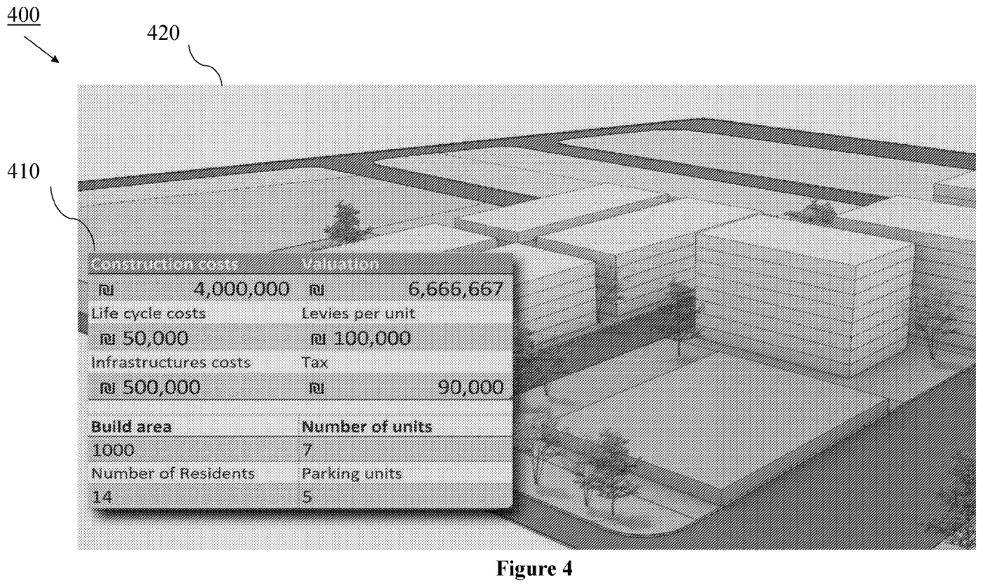

FIG. 4 illustrates an example 400 of a representation of an urban planning model and an economic feasibility analysis thereof, in accordance with some embodiments of the present disclosure.

According to some embodiments of the present disclosure, the economic viability module 330 in FIG. 3 may generate an economic feasibility analysis of an urban planning model, such as urban planning model 420, based on an analysis of plurality of model-parameters, against a environment-set-of-parameters. A representation of the economic feasibility analysis may be such as economic feasibility analysis 410. The economic feasibility analysis 410 of this example includes constructions costs of 4,000,000 NIS and valuation of 6,666,667 MS. The Life cycle costs have been calculated to be 50,000 NIS and the levies per unit 100,000 MS. The infrastructure costs 500,000 NIS and the Tax 90,000 for a build area of 1000 m², having 7 units for 14 residents and 5 parking units.

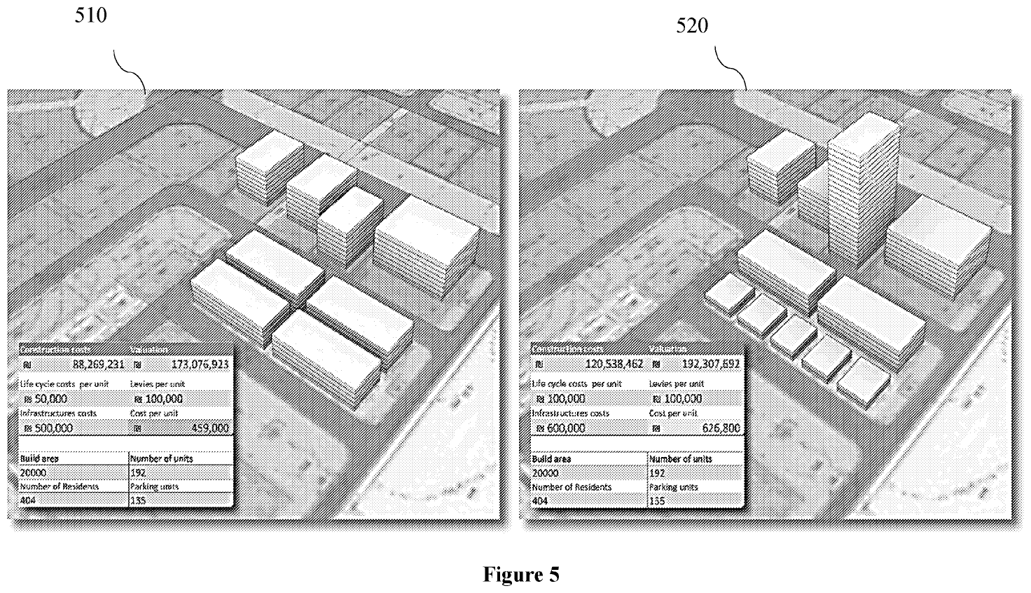

FIG. 5 illustrates an example of a representation of two alternatives of an urban planning model and an economic feasibility analysis thereof, in accordance with some embodiments of the present disclosure.

According to some embodiments of the present disclosure, two alternatives 510 and 520 of an urban planning model, such as urban planning model 110 in FIG. 1 and urban planning model 310 in FIG. 3 are provided. Both alternatives 510 and 520 have building area 20,000 and same number of units 192 and number of residents 404 with 135 parking units. For alternative 510, the construction costs are 88,269,231 MS and the valuation is 173,076,923 NIS. The life cycle costs per unit is 50,000 MS, the infrastructure costs are 500,000 NIS and the cost per unit is 459,000 NIS. Alternative 510 is having the same amount for the levies per unit as alternative 520 of 100,000 NIS but different construction costs and valuation.

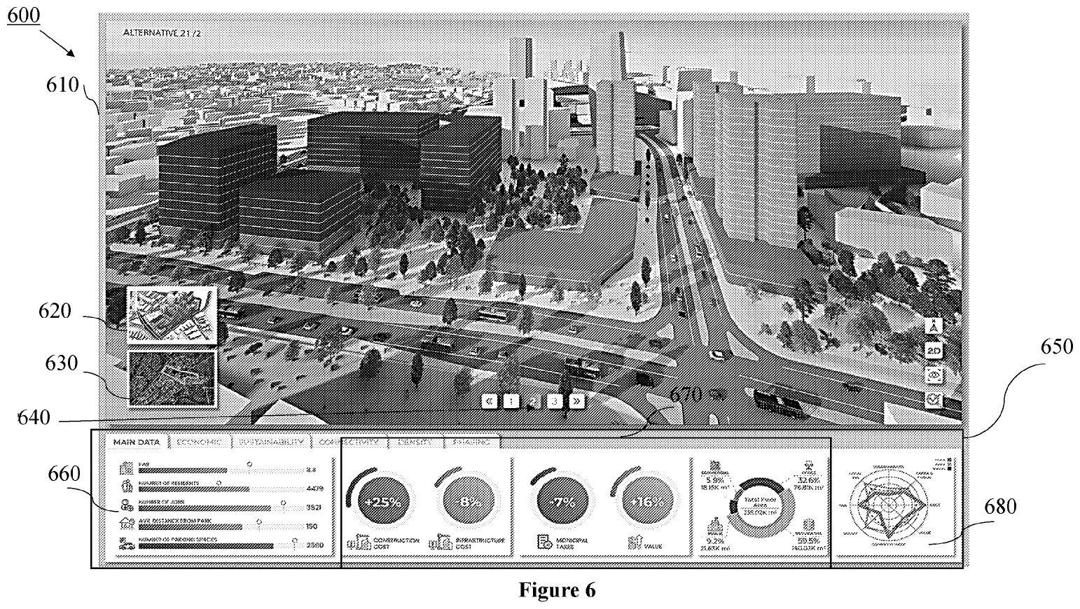

FIG. 6 illustrates an example 600 of a representation of an urban planning model with traffic and a detailed economic feasibility analysis, in accordance with some embodiments of the present disclosure.

According to some embodiments of the present disclosure, an urban planning model, such as, urban plan 110 in FIG. 1, may be represented on a display unit via a user interface. The representation of the urban planning model may include a display of both two-dimensional view, such as two-dimensional representation 620 and three-dimensional view, such as three-dimensional view 610 of the urban plan model and a plan scheme of the land use and built areas and spatial entities locations and symbols, such as plan scheme 630.

According to some embodiments of the present disclosure, an economic viability module, such as economic viability module 115 in FIG. 1, and economic viability module 200 in FIGS. 2A-2B may enable a user to switch between multiple urban planning models, such as element 640.

According to some embodiments of the present disclosure, a dashboard at-a-glance data visualization of key indicators, parameters, and analysis that may be relevant to an urban planning model and user type, such as dashboard 650 may be also included in the representation, such as representation 600.

According to some embodiments of the present disclosure, element 650 may represent an aggregation of a change between compared urban planning models and a benchmark urban planning model.

According to some embodiments of the present disclosure, element 660 may represent a change in quantitative parameters such as Floor Area Ratio (FAR) and population.

According to some embodiments of the present disclosure, element 670 may represent a change in four key economic indicators construction costs, infrastructure costs, levies and municipal tax change, and value, the built area by usage,

According to some embodiments of the present disclosure, element 680 may represent a radar map of key quantitative parameters.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-system to provide an economic feasibility analysis for an urban planning model, the computerized-system comprising:
a plurality of databases;
a memory to store the plurality of databases; and
a processor,
said processor is configured to operate an economic viability module, the economic viability module comprising:
receiving an urban planning model in a design-object format;
importing the received urban planning model into a visual programming language and environment;
retrieving urban site related metadata from the urban planning model;
according to the retrieved urban site related metadata, converting the urban planning model, which was imported into a visual programming language and environment, to a parametric model by a first pretrained machine learning model,
wherein the parametric model is having a plurality of model-parameters;
retrieving a preconfigured environment-set-of-parameters of an environment in a preconfigured distance radius from the received urban planning model,
wherein the preconfigured environment-set-of-parameters is retrieved from the plurality of databases;
forwarding the preconfigured environment-set-of-parameters to one or more economic calculators, wherein the one or more economic calculators analyzes the plurality of model-parameters against the environment-set-of-parameters, by a set of rules and a second pretrained machine learning model;
generating an economic feasibility analysis of the urban planning model, based on the analysis of the plurality of model-parameters, against the preconfigured environment-set-of-parameters; and
presenting the economic feasibility analysis, on a display unit of a computerized device.

2. The computerized-system of claim 1, wherein the economic feasibility analysis includes at least one of: (i) list of costs and (ii) value of the urban planning model, and (iii) cost-benefit analysis.

3. The computerized-system of claim 1, wherein the list of costs includes at least one of: (i) construction implementation or installation costs per project or per segment (ii) infrastructure costs per project or per segment.

4. The computerized-system of claim 3, wherein the construction costs include at least one of: (i) costs of construction and development project costs per unit or per tradable area; (ii) cost of construction of streets and roads per area; (iii) cost of open spaces development per area; and (iv) cost of mobility and parking solutions per area.

5. The computerized-system of claim 1, wherein the value of the urban planning model includes at least one value of tradable areas of: (i) value of residential unit; and (ii) value of commercial area.

6. The computerized-system of claim 1, wherein the cost-benefit analysis includes at least one of:
i. plan economic feasibility analysis;
ii. plan phasing economic feasibility analysis;
iii. plan economic feasibility analysis urban renewal project;
iv. plan economic feasibility analysis of levies and regulation benefits; and
v. a program for public needs.

7. The computerized-system of claim 1, wherein the plurality of model-parameters includes at least one indicator of: (i) economic indicators; (ii) environmental indicators; (iii) infrastructure development indicators; (iv) mobility indicators; (v) social indicators; and (vi) full implementation or structural implementation.

8. The computerized-system of claim 7, wherein the economic indicators include at least one of: costs of construction; cost of parking solutions; value of tradeable areas; economic analysis; a program for public needs; and municipal balance indices.

9. The computerized-system of claim 7, wherein the environmental indicators include at least one of: access to solar radiation rights; radiation; walkability; urban density; wind simulation of wind direction; street noise and pollution corridors; open spaces and parks access and ratio to population and density; and viewshed analysis.

10. The computerized-system of claim 7, wherein the infrastructure development indicators include at least one of: (i) earthworks cut and fill analysis; (ii) watershed and drainage analysis; (iii) roads paving costs in relation to transportation requirements; (iv) infrastructure construction costs to residential units.

11. The computerized-system of claim 7, wherein the mobility indicators include at least one of: space syntax grid network; analysis of walking distance to points of interest and attraction points; index-integrated planning public transport; street sections with street users; and transportation demand management distribution forecasts.

12. The computerized-system of claim 1, wherein the economic feasibility analysis is a current value.

13. The computerized-system of claim 1, wherein the economic feasibility analysis is a future value, wherein the future is a preconfigured period time in the future.

14. The computerized-system of claim 1, wherein after the receiving of the urban planning model, presenting the urban planning model, in a graphic presentation, on a display unit associated with a computerized device.

15. The computerized-system of claim 14, wherein a user is enabled to perform one or more modifications to the urban planning model, via an input device, and wherein an estimation of economic viability is operated for the modified urban planning model.

16. The computerized-system of claim 14, wherein a search algorithm dedicated to multi-objective search is enabled to perform one or more modifications to the urban planning model, via an input device, and wherein an estimation of economic viability is operated for each of the modified urban planning models for performance assessment.

17. The computerized-system of claim 15, wherein a modification of the urban planning model includes a change of at least one object in the at least one object: (i) location; (ii) layout; (iii) typology; (iv) Floor Area Ratio (FAR) (v) parcel to lots division; (vi) entrance location and type (vii) right of passage; (viii) land uses; (ix) access to public transportation; (x) parking; (xi) setbacks lines; (xii) units size; (xiii) total tradable area; (xiv) service area ratio; (xv) underground layout and depth; (xvi) model entrances altitudes; (xvii) segments construction and marketing phasing and implementation ratio; (xviii) model population density; (xix) altitude; and (xx) regulatory and local public requirements.

18. The computerized-system of claim 1, wherein the economic viability module is enabling a user to generate an urban planning model instead of receiving thereof via an input device.

19. The computerized-system of claim 1, wherein the one or more economic model calculators are calculating zoning and local restrictions and provide output data that is used for the generating of the economic feasibility analysis of the urban planning model, based on shape and built volume and layouts of the urban planning model.

20. The computerized-system of claim 1, wherein the urban planning model is a format selected from: (i) Computer-Aided Design (CAD) format; (ii) design considerations; (iii) constrains and rights; (iv) tables of constraints; (v) geo-data formats defining the area in one or more information layers; (vi) a combination of (i) through (v).

21. The computerized-system of claim 15, wherein the urban plan model and the modifications to the urban plan model are presented on a display unit in a three-dimensional view or two-dimensional view.

22. The computerized-system of claim 20, wherein the urban plan model and the modifications to the urban plan model are rendered by a Game engine.
